(19) United States
(12) Patent Application Publication
(10) Pub. No.: US 2015/0067476 A1
(43) Pub. Date: Mar. 5, 2015

(54) TITLE AND BODY EXTRACTION FROM WEB PAGE

(71) Applicant: Microsoft Corporation, Redmond, WA (US)

(72) Inventors: Ruihua Song, Beijing (CN); Guangping Gao, Beijing (CN); Qian Zhang, Issaquah, WA (US); Ming Liu, Bellevue, WA (US); Raman Narayanan, Seattle, WA (US); Shelley Summer Gu, Seattle, WA (US); Yanti Aruswati Gouw, Bellevue, WA (US)

(73) Assignee: Microsoft Corporation, Redmond, WA (US)

(21) Appl. No.: 14/037,324

(22) Filed: Sep. 25, 2013

(30) Foreign Application Priority Data
Aug. 29, 2013 (CN) 3110013745.1

(51) Int. Cl. G06F 17/30; G06F 17/22

(52) U.S. Cl. CPC G06F 17/30896; G06F 17/2247; G06F 17/30598
USPC 715/234

(57) ABSTRACT

Technologies are generally provided for extracting a body and a title of an article displayed on a web page. A web page may display content such as advertisements, images and links in addition to the web page article. A user may select to view the article in a reader application without the additional content, and the reader application may extract the body and the title from the web page. Title candidates may be selected by identifying meta tags associated with the title and removing website names from the meta tags. Body candidates may be selected by identifying clusters of text nodes based on a font size and depth in a document object model tree for the web page. A best cluster that is most likely the body may be selected and a corresponding title candidate maybe selected as the best title.

### BACKGROUND

Web sites may display a variety of articles such as informational articles, newspaper articles, blogs, and other textual content. In addition to displaying the article, a web page may display a variety of other content such as advertisements, links to other web pages, buttons for sharing, printing, and emailing an article, navigational links and buttons, audio/visual content, and other similar content. The additional content may be distracting for a reader of the article, and often times a reader may select to view the article in a reader application where the main content of the article may be displayed without additional distracting content. A reader application may need to distinguish portions of content related to the article from unrelated content displayed on the web page in order to select content to display the article in a reading view.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to extracting a body and a title of content such as an article displayed on a web page for viewing in a reader application. A user may select to view the content in a reader application without additional content displayed on the web page such as such as advertisements, images and links in addition to the web page article. The reader application may extract the body and the title from the web page. Title candidates may be selected by identifying meta tags associated with the title and removing website names from the meta tags. Body candidates may be selected by identifying clusters of text nodes based on a font size and depth in a document object model tree for the web page. A cluster that is most likely the body may be selected and a corresponding title candidate maybe selected as the title.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example conversion of a web page article to a reading view;

FIG. 2 illustrates an example web page article where a system for extracting title and body content may be implemented;

FIG. 3. Illustrates an example web page article for extracting title and body content;

FIG. 4 illustrates an example schematic for extracting title and body content from a web page article;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of extracting body and title content from a web page article according to embodiments.

### DETAILED DESCRIPTION

As briefly described above, a system is described for extracting a body and a title of an article displayed on a web page for viewing in a reader application. A web page may display a variety of content such as such as advertisements, images, comments, and links in addition to the article, and a user may desire to view the article in a reader application without viewing the additional content. In order to display the article without the additional content, a body and a title of the article may be extracted from the web page. Title candidates may be selected by identifying meta tags associated with the title and removing website names from the meta tags. Body candidates may be selected by identifying clusters of text nodes based on a font size and depth in a document object model tree for the web page. A best cluster that is most likely the body may be selected, and a corresponding title candidate maybe selected as the best title. The reader application may apply a filtering process to remove nodes including unrelated content from the web page.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

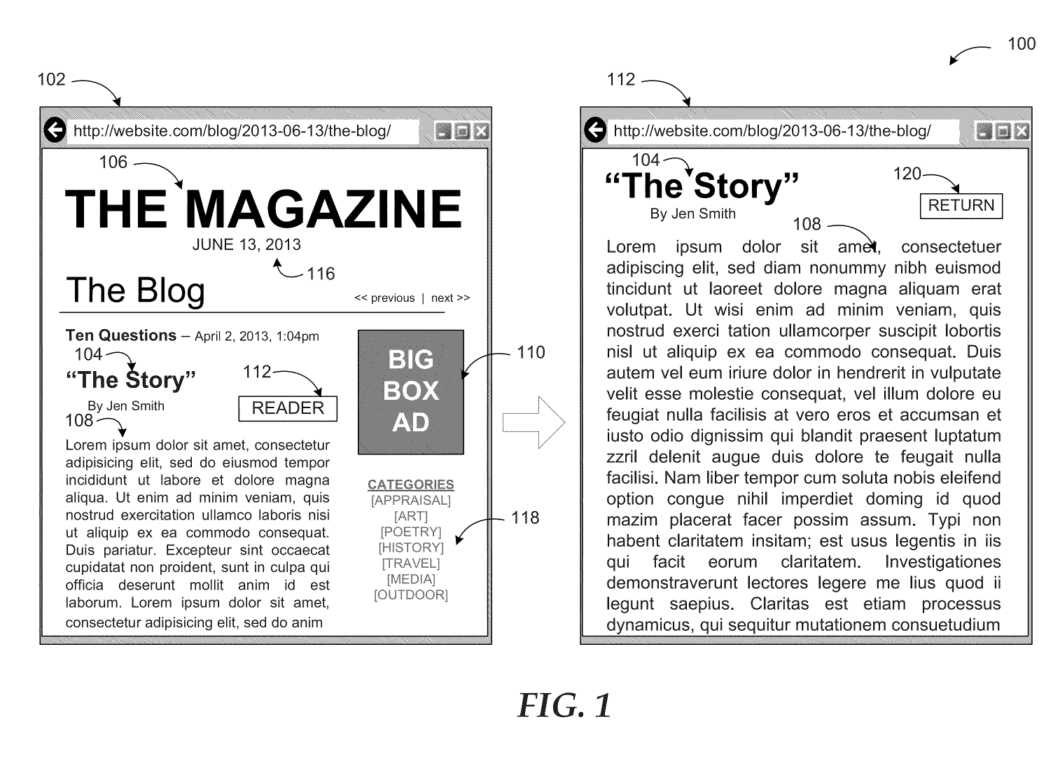

FIG. 1 illustrates an example conversion of a web page article to a reading view, according to some embodiments described herein.

The computing device and user interface environment shown in diagram 100 are for illustration purposes. Embodiments may be implemented in various local, networked, and similar computing environments employing a variety of computing devices and systems. As illustrated in diagram 100, content may be viewed on a client device 102. Example computing devices may include a smart phone, a tablet, an e-reader, a personal digital assistant (PDA), whiteboard, a personal computer, a desktop computer, or other similar computing devices for viewing and interacting with content.

Example content may be provided over a network such as a cloud network, and may be accessed on a device, such as a tablet, through a web browser. Example content viewed on the client device 102 may be an article viewed on a web page. An example web page article may be a blog, an informational article, a newspaper article, or other similar content. An example web page article may include a title 104 of the article and a body 108 of the article. When the web page article is viewed in an original format from an original source on the web page, the web page may also display additional content, such as a source or website name 106 that hosts the article, time and data information 116 associated with the article and the web page, categories and/or topics 118 associated with the article, audio/visual content associated with the article, and other similar content. Furthermore, the web page displaying the article may also display content unrelated to the article such as advertisements 110, images, titles of other content viewable on the web page, links to sites, and other similar content for example.

In an example embodiment, when the web page article is viewed on the client device 102, a user may desire to read the article without viewing the additional content displayed on the web page. For example, the user may view the web page article on a tablet or smart phone, which may have a smaller display, and the additional displayed content may prevent the user from optimally reading the body of the web page article.

In a system according to embodiments, the user may select to convert the web page article to a reading view 112, which may be opened in a reader application. In the reading view 112, the title 104 and the body 108 of the viewed web page article may be extracted from the web page and displayed on the client device. The additional extraneous content may be hidden from view when the web page article is displayed in the reading view. After viewing the web page article in the reading view 112, the user may return 120 to the web page to continue viewing and interacting with the original content displayed on the web page, and the additional extraneous content may be displayed in the original web page format.

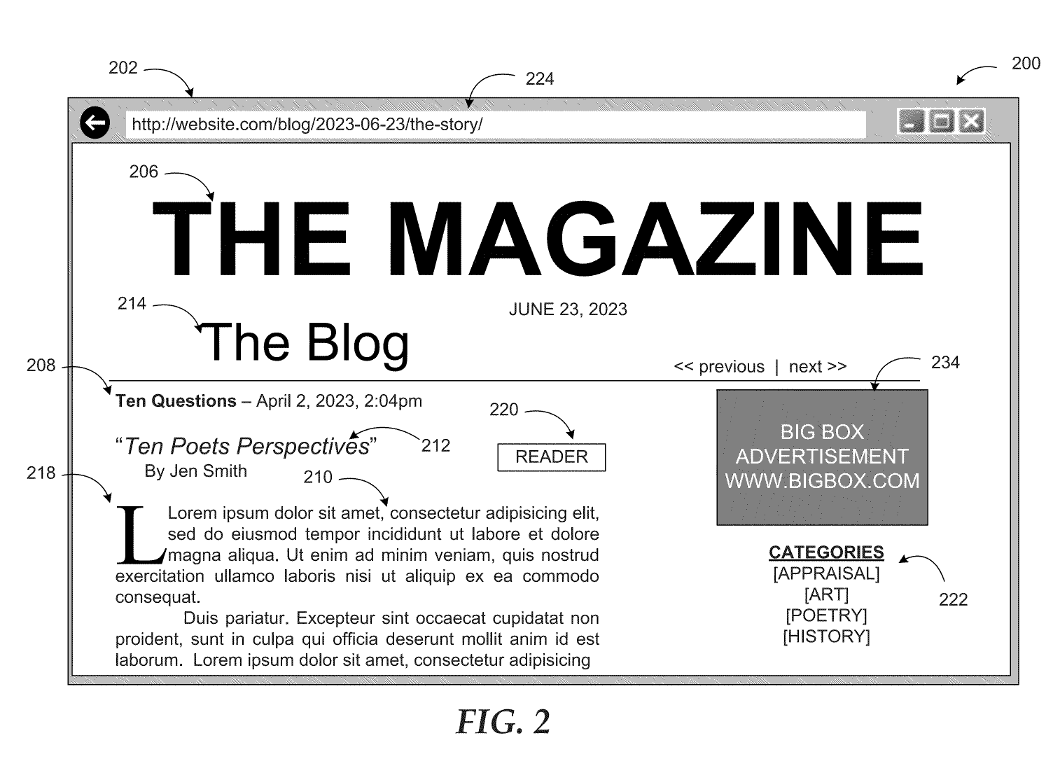

FIG. 2 illustrates an example web page article where a system for extracting title and body content may be implemented, according to some embodiments discussed herein.

As demonstrated in diagram 200, a web page article may be viewed on a client device such as a tablet or smart phone device. The article may be accessed through a web browser on the client device, the article content may be provided by a web site. The web site displaying the article may display a title 212 and a body 210 of the article on the web page. As previously described, additional content may also be displayed on the web page, such as a web page name 206 or source, audio/visual content such as pictures and advertisements 234, textual content 222 related to the web page, links to other web pages, and other similar content.

In a system according to embodiments, a user may select to convert the article to a reader 220 view where the title 212 and the body 210 of the article may be displayed without additional unrelated content. In order to convert the article to the reader 220 view, the title 212 and body 210 content may be extracted from the web page.

A system according to embodiments may apply an extraction algorithm to identify and extract the title 212 and body 210 content from the web page. In an example scenario, candidates for the title 212 may be identified, then candidates for the body 210 may be identified, and subsequently a best combination of the title 212 candidates and the body 210 candidates may be identified such that identification of the body 210 and the title 212 may be correlated and reinforced.

In an example embodiment, the candidates for the title 212 may be determined by identifying title nodes of the web page. The web page may be built employing Hypertext Markup Language (HTML), extensible Hypertext Markup Language (XHTML), extensible markup language (XML), or similar structural languages. The article may be rendered employing a Document Object Model (DOM) which may be a platform and language-independent convention for representing and interacting with HTML, XTHML and XML objects. In the DOM platform, every HTML object is a node and the nodes of the document are organized in a tree structure, called a DOM tree. Objects of the DOM tree may include a document node representing the entire document, an element node where every element node is an HTML element, a text node representing any text inside an HTML element, and an attribute node which is an HTML attribute, for example.

Additionally, the article may include a variety HTML meta tags, or title nodes, which may be associated with the title of the article. Example HTML meta tags associated with the title of the article may be a meta title tag, an open graph meta tag, and a meta content tag. A meta title tag may include the title of the article as the text of the title tag. An open graph meta tag may provide information about the article to be displayed when the article is shared on another platform, such as a social media platform. A meta content tag may provide information about the article that may be used by search providers to determine a context of the article. One or more of meta title tag, open graph meta tag, and meta content tag may be commonly used to define the title of an article on a web page.

In a system according to embodiments, one or more title candidates may be determined by identifying a font size of text nodes within the DOM tree for the article, and matching the font size with meta tags associated with the title. Font size may a text feature that may indicate a title, because often the title is the most salient text fragment on a web page and may be the largest font. Font size alone may not be an accurate indicator of the title 212, because in some scenarios content other than the title may have a larger font size. For example, as illustrated on the web page 202 of diagram 200, the web page name 206 and a category 214 of the article have a larger font size than the title 212. Text nodes having larger font sizes may be initially selected as title candidates, and matching the text nodes having larger font sizes with HTML title meta tags may facilitate accurately detecting the title.

In an example embodiment, the system may identify the presence of a meta title tag, an open graph meta tag, and a meta content tag in the HTML for the web page. Common text content included in each of the meta title tag, open graph meta tag, and meta content tag may indicate a most likely candidate for the title. In some scenarios, one or more of the meta title tag, open graph meta tag, and meta content tag may also include text for the web page name 206, site name, or a directory name, for example. When the web page name 206 (or other similar site name) appears in one of the meta title tag, open graph meta tag, and meta content tag, the web page name 206 may be determined to be more similar than the true title 212 according to a similarity function, for example an edit distance or Jaccard similarity index. The Jaccard similarity index may statistically measure a similarity between sample sets. If the web page name 206 has a higher similarity than the true title 212 in each of the title tags, then the web page name 206 may be incorrectly identified as a title candidate.

In a system according to embodiments, the web page name 206 may be filtered out of the meta tags in order to identify the title 212. In one example filtering method, the system may identify an indicator such as a dash, a colon, a slash, and/or a vertical bar contained within the tag. If only one indicator is identified within the tag, then it may be presumed that text before the indicator may be the web page name 206, and the text after the indicator may be the title 212. For example a title tag may be <title> Website:thestory </title>, where the text before the colon, “website,” may be the web page name, and the text after the colon, “The Story,” may be the title of the article.

Another filtering method may also be employed to separate the web page name from the title 212 based on a uniform resource locator (URL) 224 of the web page. The URL 224 for the web page may be normalized by identifying the last forward slash in the URL 224. If the text following the last slash includes index/default, then the last slash and text following the last slash may be removed. Other words such as “homepage”, etc. may also be removed. After removal of the last slash and following text, the normalized URL 224 may include two parts, which may be defined as a path and a file. The file may be the portion of the URL 224 following a last forward slash in the URL 224, and the path may be the portion of the text preceding the last forward slash. For example, a URL for the web page may be “news.website.com/blogs/trendingnow/the-story-is-true/index.html.” The index/default may be removed, and the remaining URL may be divided into a path and a file, where the file may be “The Story is True-123908.html” and the path may be “news.website.com/blogs/trendingnow.” The text portion represented by the file may include the title 212 of the article and may be identified as a title candidate. The path may include the web page name and/or the directory name, and the path may be removed to improve the accuracy of the identified title candidate.

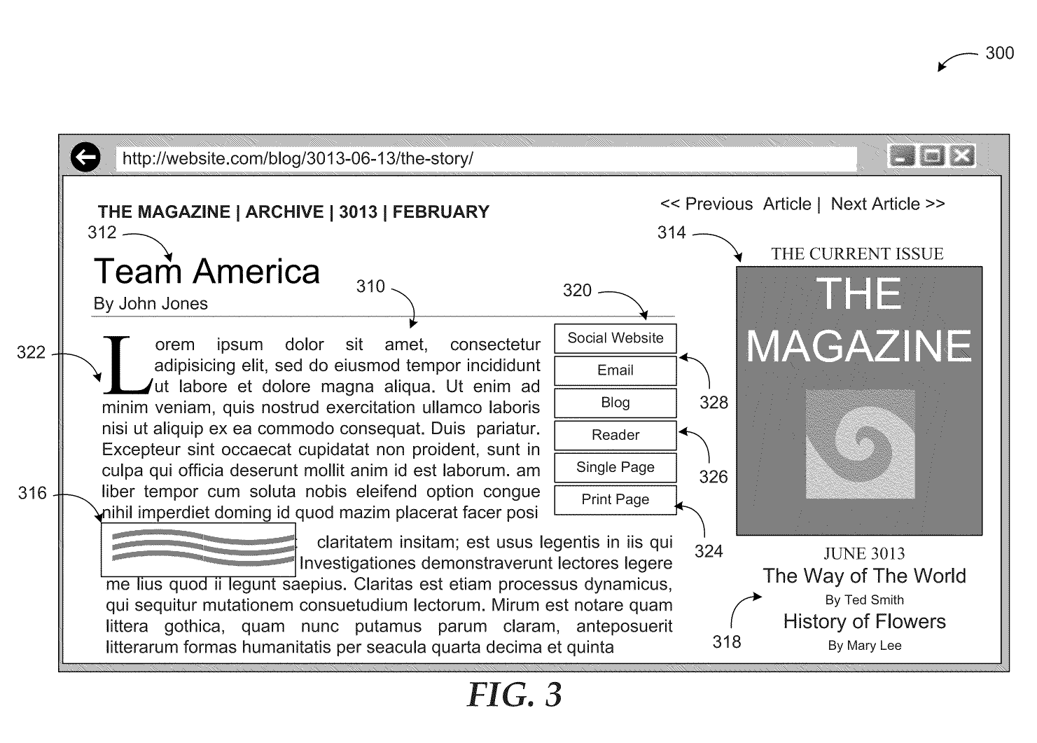

FIG. 3 illustrates an example web page article for extracting title and body content, according to some example embodiments described herein.

In a system according to embodiments, as demonstrated in diagram 300, after identification of one or more title candidates based on meta title tags and font size, the best title candidate may be determined based on comparison of the title candidate with text node clusters of the web page. A body extraction algorithm may be applied to identify a best cluster of text nodes for each title candidate. After the best cluster is identified for a title candidate, the method may be iteratively applied to identify a best cluster for each of the title candidates.

In an example embodiment, given a title candidate, text nodes of the web page may be searched to identify nodes that may be likely to belong to the body 310 of the article. In some examples, it may be assumed that paragraphs of the body 310 of the article may have a similar font size and similar text lengths, and may be at a same depth in the DOM tree for the web page. In order to begin selection of body candidates, text nodes whose inner text length is larger than a threshold length may be clustered together. The threshold length may be a predefined length and may be configurable. From the clustered text nodes having a length larger than the threshold length, two or more text nodes having the same font size and same depth may be grouped together in a cluster. The process may be repeated for remaining text nodes of the web page, resulting in a plurality of clusters of text nodes, where the text nodes in each cluster have a same font size and DOM depth.

After accumulation of the plurality of clusters for the web page, the clusters may be compared to measure a common font size of each cluster, the summed text length of each cluster, and the number of text node members in each cluster. A best cluster candidate may be selected based on the font size, summed length and number of members. In an example embodiment, the cluster with the largest font size and a large summed text length may be selected as the best cluster candidate. A large summed text length may a text length larger than a predefined threshold number of characters (e.g., 500), for example. A second choice for the best candidate may be a cluster with the largest summed text length, and a third choice for the best candidate may be the cluster with the largest number of members.

After selection of the best cluster candidate for each title candidate, the best title 312 may be determined based on comparison of the identified best clusters with the title candidates. A title candidate whose best cluster candidate has the largest font size and a title candidate whose best cluster candidate has a longest inner text length may be identified. The most likely body may be the cluster having the longest inner text length. Additionally, the cluster with the largest font size text that also has an inner text length greater than a predefined length of inner text may be the body. For example, a cluster with an inner text length of larger than a predefined threshold number of characters (e.g., 500) and a font size larger than the cluster with the longest inner text may be a most likely body cluster. The title candidate corresponding to the most likely body cluster may be selected as the best title candidate. Additionally, if more than one best cluster has a same inner text length, then the title candidate with the closest corresponding text may be selected as the best title candidate.

In a further embodiment, after selection of the best title candidate, the best title candidate may be adjusted based on surrounding text to refine the accuracy of the selected best title candidate. If a text node preceding the best title candidate has a larger font size, the preceding text node may replace the best title candidate. Additionally, if the best title candidate has an inner text length of less than two, such as when a first letter 322 of a text node is a large font size, surrounding text nodes may be searched until a text node having a font size larger than a predefined threshold (e.g., 29 pt or 1.5 times the previous font size) is identified, for example. When a text node having the defined font size is identified, the identified text node may be selected as the best title candidate.

In an example embodiment, an algorithm may be applied to identify a main block of the web page that may be likely to include the body of the web page article. Identifying the main block may reduce a number of text nodes to search when identifying identify text nodes of the web page that likely complete the best cluster for the body. The algorithm may be based on the DOM tree for the web page. For example, after identification of the title candidates, the DOM tree may be searched upwards until an HTML body node is identified. After the HTML body node, parent text nodes may be identified, and for each parent text node, a ratio of a current inner text length to a previously inner text length may be computed. A node with the maximum inner text ratio may be selected, and the nodes maybe searched up the DOM tree if the parent's inner text ratio is decreasing compare to the child node. When the ratio stops decreasing, a current child node may be selected as a first candidate. Similarly, the nodes may be searched down the DOM tree from the HTML body node to the title node. A ratio of the inner text length to the inner HTML length may be computed, and the nodes may continue to be searched down the DOM tree if the ratio continues to increase. When the ratio stop increasing, a current parent node may be regarded as a second candidate. The first and second candidates may be compared, and the candidate with a lower depth in the DOM tree may be selected as a main block. The text nodes within the identified main block may be searched according to the method described above in order to identify the best cluster candidates.

As previously discussed, the best cluster candidate may be a portion, or a seed, of the entire body, and further analysis may be performed to complete the body after selection of the best title candidate. In order to complete the body, the text nodes of the web page may be processed to add paragraphs that have a shorter text length, different font size, and are lower or deeper in the DOM tree than the body seed. Additionally, inline images 316 may be added to the body seed, and lists and/or tables identified as part of the body may be added to the body seed.

In an example embodiment, to add more paragraphs to the body seed, remaining text nodes of the web page may be searched beginning with the text node next to the best title candidate. If the text node has a font size larger than the best cluster font size and the DOM depth difference is less than two, the text node may be added to the best cluster. Text nodes may continue to be added to the best cluster until keywords are identified that indicate the text node is not a part of the body. Example keywords may be words that indicate an end of the web page article, such as “Related Stories,” “Related Post,” and “File Under.” After a text node including the defined keywords is identified, adding text nodes to the best cluster may be stopped because it may be likely that text nodes after the end of the web page article do not belong to the body of the web page article.

In another example embodiment, in order to add an inline image 316, it may be presumed that text surrounding an inline image may likely be in the best cluster. To identify an inline image 316, parent nodes of at least two adjacent text nodes in the best cluster may be identified. The number of occurrences of each parent node may be counted and the parent nodes may be ranked based on occurrence from the most common parent node to the least common parent node. Child nodes for each parent node may be analyzed, and if the most inner text of a child node has already been in the best cluster, then the child node may be labeled as a body. An inline image 316 between adjacent child nodes may be extracted and added to the best cluster candidate for the body. A frequency of the children nodes tags may also be determined, and if a child node has a most frequent tag, the ratio of plain text to all inner text and the ratio of inner text to inner HTM may be determined. If the ratios are larger than thresholds, the child node may also be added to the body.

Similarly, to complete a list or a table included in the body, the most common parent node may be identified and the child nodes for the most common parent node may be analyzed. If the most frequent tag is a table tag such as <tr>, the DOM tree may be searched to identify a node whose tag is <table> and the content after the <table> tag may be labeled as part of the body. Additionally, if the most frequent tag is a list tag, such as <li>, the DOM tree may be searched to identify a node whose tag is <ul> or <ol> which may indicate ordered information. Content after the <ul> or <ol> may be labeled as part of the body.

In a further embodiment, after completing the best cluster for the body of the web page article, the body may be filtered to remove nodes that may have been added to the best cluster but may not be part of the body, such as advertisements, images 314, navigation nodes 320 such as share-to-social network buttons, print links 324, display links 326, email links 328, related stories, comments, and other similar unrelated textual content 318. In an example filtering method, heuristic rules may be employed to identify and filter out navigation nodes. A navigation node may be composed of the links to navigate to other sites like related articles, advertisements, and external sites or applications. An example heuristic rule may identify if the node includes predefined advertisement keywords or names of advertisements sources. If the node includes the predefined keywords, the node may be removed. Another example rule may be to identify if a node includes a link containing a well-known ad. host name. A link containing a well-known ad.host name may be an ad-link or the link whose innerText contains some typical ads keywords may also be an ad-link, or if the link (http://, . . . ) is really long, it may imply it is an ad-link, and may be removed. If inside the node, a ratio between the ad-link count to the link count is greater than threshold, it may be determined to be a navigation node, and the node may be removed. If inside the nodes ratio between the links innertext character count and the whole nodes character count is greater than some threshold, the nodes may be treated as a navigation node and therefore may be removed. In a further example, a rule may be that if a ratio between an inner text count of the link and an inner text count of the whole node is greater than 0.48, it may likely be a navigation node, and the node may be removed.

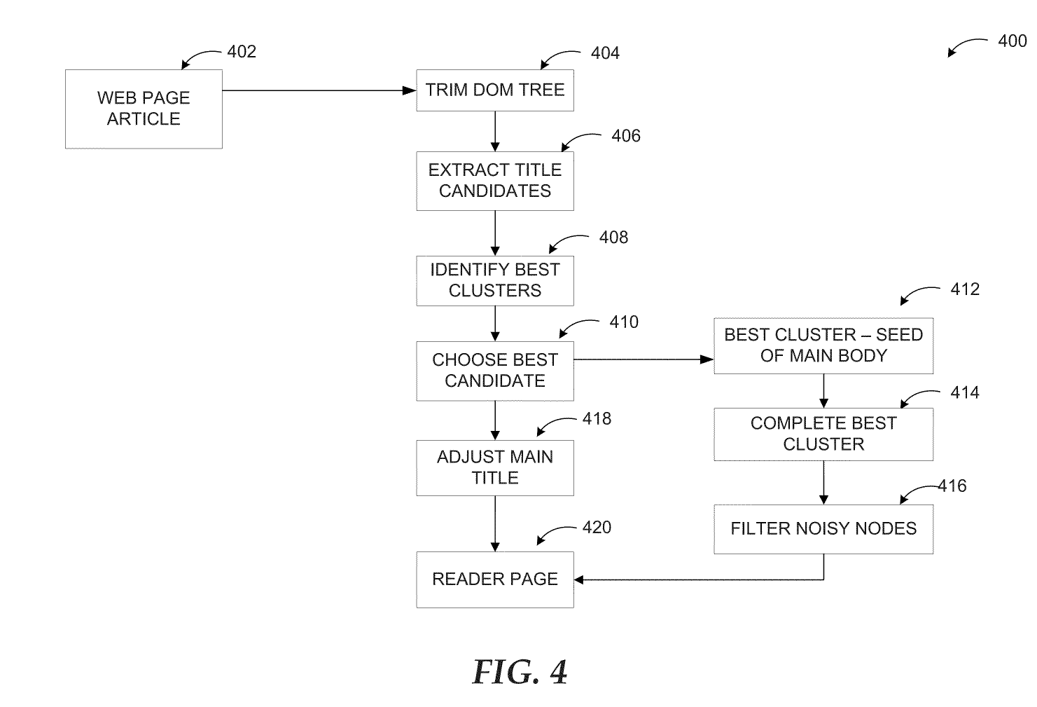

FIG. 4 illustrates an example schematic for extracting title and body content from a web page article.

As described above, a title and a body of a web page article may be extracted in order to view the web page article in a reader application without viewing extraneous and unrelated content from the web page. When the title and the body are viewed in the reader application, a user may interact with the title and the body. For example, the title may be zoomed, and the user may select, highlight, and annotate portions of the body. Additionally, the title may be displayed in a library page associated with the reader application where a list of article titles may be presented and selected by a user.

As illustrated in diagram 400, extracting a title and a body of a web page article may begin by identifying a web page that displays at least one web page article 402. After identification of the web page article, an initial filtering process may be performed to trim a DOM tree 404 for the web page article. Some nodes with special tags may have a low probability of being the title or body of the web page article. Example nodes may be <script>, <input>, <style>, <cite>, <iframe> and <noscript>. Additionally, some nodes with special combinations of tag, attribute, and value may also have low probability to be title or body. The nodes with low probability of being the body and title of the web page article may be trimmed from the DOM tree 404. An example process for trimming the DOM tree may be:

```
this.trimTagsAndAttr = {
    “div”: {
      “class”: {
          “mboxdefault”: true,
          “controls”: true,
          “control”: true,
          “buttons”: true,
          “button”: true,
          “share”: true,
          “hidden”: true,
          “hide”: true,
          “left-ear”: true,
          “right-ear”: true,
          “ad”: true,
          “ad_”: false,
          “nocontent”: false,
          “nocontents”: false,
          “promo_holder”: false,
          “promo-component”: false,
          “comment”: false,
          “sharebar”: false,
          “share-tool”: false,
          “sharetool”: false,
          “social”: false
      },
      “id”: {
          “comment”: false,
          “sharebar”: false,
          “share-tool”: false,
          “sharetool”: false,
          “social”: false,
      }
    },
    “a”: {
      “class”: {
          “hide”: true
      }
    },
    “ul”: {
      “id”: {
          “comment”: false,
          “sharebar”: false,
          “share-tool”: false,
          “sharetool”: false,
          “social”: false
      },
      “class”: {
          “comment”: false,
          “sharebar”: false,
          “share-tool”: false,
          “sharetool”: false,
          “social”: false
      }
    }
  };
this.trimTagsAndAttr = {
  “div”: [[“class”, “mboxdefault”, 1],
        [“class”, “controls”, 1],
        [“class”, “buttons”, 1],
        [“class”, “button”, 1],
        [“class”, “share”, 1],
        [“class”, “hidden”, 1],
        [“class”, “hide”, 1],
        [“class”, “left-ear”, 1],
        [“class”, “right-ear”, 1],
        [“class”, “ad”, 1],
        [“class”, “ad_”, 2],
        [“class”, “nocontent”, 0],
        [“class”, “promo_holder”, 0],
        [“class”, “promo-component”, 0],
        [“class”, “comment”, 0],
        [“class”, “sharebar”, 0],
        [“class”, “share-tool”, 0],
        [“class”, “sharetool”, 0],
        [“class”, “liveblog_”, 0],
        [“class”, “feed”, 2],
        [“class”, “sidebar”, 3],
        [“class”, “map”, 3],
        [“id”, “comment”, 0],
        [“id”, “sharebar”, 0],
        [“id”, “share-tool”, 0],
        [“id”, “sharetool”, 0],
        [“id”, “liveblog_”, 0],
        [“id”, “feed”, 2],
        [“id”, “sidebar”, 3],
        [“id”, “map”, 3],
        [“class”, “logo”, 3],
        [“id”, “logo”, 3]
  ],
  “a”: [[“class”, “hide”, 1],
    [“class”, “logo”, 3],
    [“id”, “logo”, 3]],
  “ul”: [[“class”, “comment”, 0],
    [“class”, “sharebar”, 0],
    [“class”, “share-tool”, 0],
    [“class”, “sharetool”, 0],
    [“id”, “comment”, 0],
    [“id”, “sharebar”, 0],
    [“id”, “share-tool”, 0],
    [“id”, “sharetool”, 0]
  ],
  “h1”: [[“class”, “logo”, 3],
    [“id”, “logo”, 3]],
  “h2”: [[“class”, “logo”, 3],
    [“id”, “logo”, 3]],
  “h3”: [[“class”, “logo”, 3],
    [“id”, “logo”, 3]],
  “section”: [[“class”, “comment”, 0],
    [“id”, “comment”, 0]
  ]
};
```

In the above example a format of the list may be:

```
[tag]: {
  [Attribute]: {
    [string]: true //this means the value equals to the string.
    [substring]: false //this means the value should contain the
substring.
    }}
[tag]: {
  [ [Attribute],[string],[0/1/2/3]] //0 means the value contains the
string; 1 means the value equals to the string; 2 means the value
begins with the string; 3 means the value ends with the string.
    }}
```

For instance, if a node's tag is <a> and it has an attribute “class=hide”, the node may be trimmed from the DOM tree. For another example, if a node's tag is <ul> and the value of “id” contains a substring “comment,” the node may be trimmed.

In a system according to embodiments, after initial trimming of the DOM tree 404, title candidates for the web page article maybe extracted 406. The title candidates may be determined based on identification of title meta tags of the web page. A web page name, a site name, and/or a directory name may be removed from the meta tags to improve the accuracy of the title candidates. After identification of title candidates, best clusters of text nodes for the body may be identified 408. The best clusters of text nodes may be identified for each title candidate based on a font size and depth in the DOM tree for the web page. After identifying a set of best clusters for the body, a best title candidate 410 for the title may be selected for each best cluster based on comparison of a font size and inner text length. The selected title may be adjusted 418 based on surrounding text to further refine the title. Additionally, after selection of the best title candidate for the title, the corresponding best cluster may be selected as the body seed 412.

Subsequently, the body may be completed 414 by adding paragraphs with shorter text lengths and paragraphs deeper in the DOM tree, and adding inline images, tables and lists. Furthermore, noisy nodes such as advertisements, share-to buttons, related stories, and other unrelated content may be filtered 416 out of the best cluster for the body. After the title has been adjusted 418 and unrelated content and noisy nodes have been filtered 416 out of the body, the title and the body may be extracted and displayed on a reader page 420 of a reader application.

The example systems in FIG. 1 through 4 have been described with specific configurations, applications, and interactions. Embodiments are not limited to systems according to these examples. A system for extracting body and title content from a web page article may be implemented in configurations employing fewer or additional components and performing other tasks. Furthermore, specific protocols and/or interfaces may be implemented in a similar manner using the principles described herein.

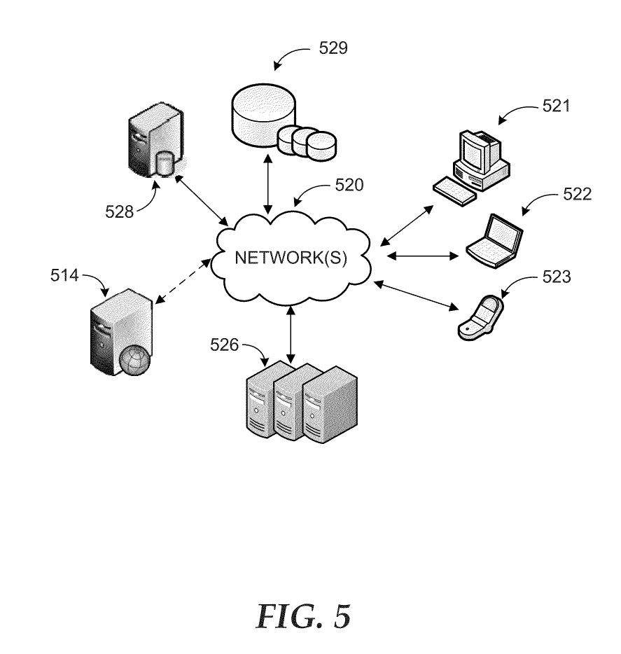

FIG. 5 is an example networked environment, where embodiments may be implemented. A system for extracting body and title content from a web page article may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An application executed on one of the servers may facilitate extracting a body and title content from a web page article. The application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform for providing a system for extracting body and title content from a web page article. Furthermore, the networked environments discussed in FIG. 5 are for illustration purposes only. Embodiments are not limited to the example applications, modules, or processes.

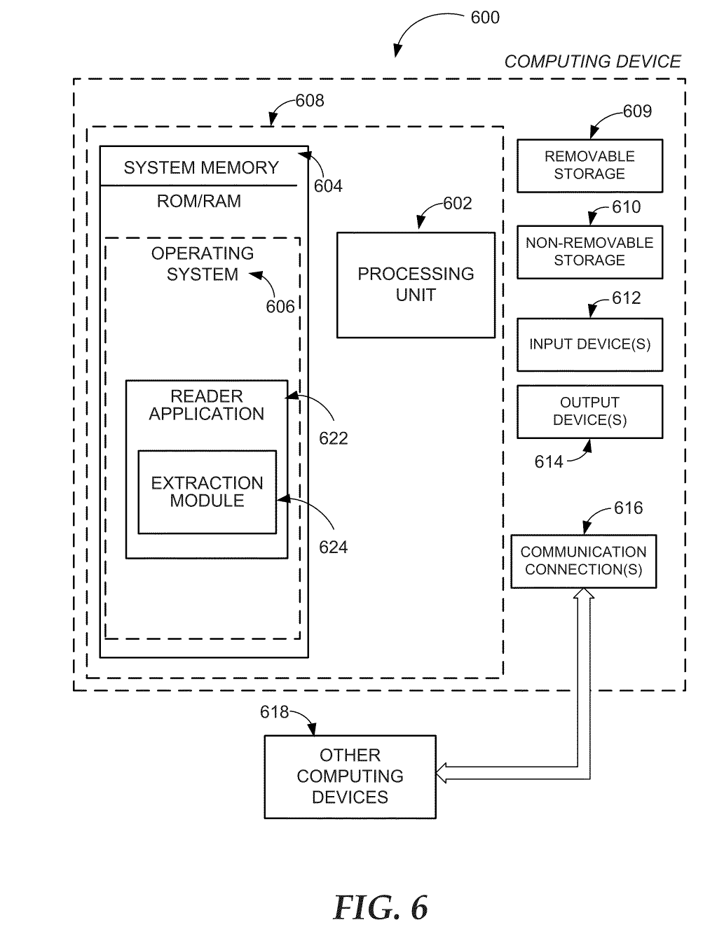

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application for providing a system for extracting body and title content from a web page article according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS® operating systems from MICROSOFT CORPORATION of Redmond, Wash. The system memory 604 may also include one or more software applications such as a reader application 622 and an extraction module 624.

The reader application 622 may be an application enabling viewing of a web page article in a reading view where a body and title of the article may be displayed without displaying extraneous and unrelated content from a web page. An extraction module 624 as part of the reader application 622 may facilitate identifying a web page article, and executing an algorithm to extract the title and the body of the web page article from the web page. The algorithm may identify one or more title candidates and may facilitate selecting the best title from the title candidates and the best body candidate from the set of best cluster candidates for the body. Reader application 622 and extraction module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

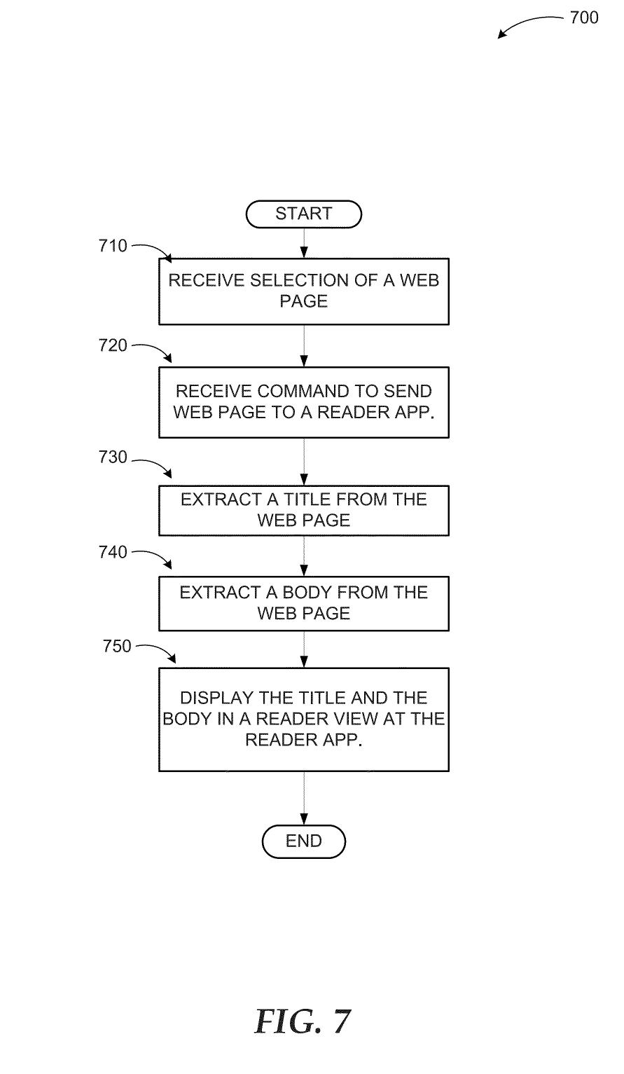

FIG. 7 illustrates a logic flow diagram for process 700 of extracting body and title content from a web page article, according to embodiments. Process 700 may be implemented on a computing device or similar electronic device capable of executing instructions through a processor.

Process 700 begins with operation 710, where a selection of a web page displaying an article may be received. The web page may display other content in addition to the article such as links, advertisements, images, share-to-social network buttons, print or email links, related stories, comments, and other similar unrelated textual content. At operation 720, a command to view the article in a reader application may be received. At operation 730, upon receiving the command to view the article in a reader application, a title of the article may be extracted from the web page. At operation 740, a body of the article may also be extracted from the web page. The body and the title may be extracted employing an algorithm for identifying best title candidates and best cluster candidates for the body, and selecting related candidates for the title and body. At operation 750, the extracted title and extracted body may be displayed in a reading view at the reader application.

The operations included in process 700 are for illustration purposes. Extracting body and title content from a web page article may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for extracting body and title content from a web page article, the method comprising:
receiving a selection of a web page displaying an article;
receiving a command to view the article in a reader application;
extracting a title of the article from the web page;
extracting a body of the article from the web page; and
displaying the extracted body and title in a reading view at the reader application.

2. The method of claim 1, wherein extracting the title of the article further comprises:
identifying one or more meta tags associated with the title of the web page.

3. The method of claim 2, further comprising:
selecting one or more title candidates based on text content included within the one or more meta tags.

4. The method of claim 3, further comprising:
filtering out a web page name from the text content included within the one or more meta tags.

5. The method of claim 2, wherein extracting a body of the article further comprises:
identifying two or more text nodes having an inner text length larger than a predefined threshold length;
selecting at least two text nodes having a same font size and a same Document Object Model (DOM) tree depth from the two or more text nodes having an inner text length larger than the threshold length;
grouping the at least two next nodes together in a cluster; and
repeating to produce a cluster for each title candidate.

6. The method of claim 5, further comprising:
selecting a best cluster candidate for each title candidate as the cluster with a largest font size and a large summed text length, wherein the large summed text length is a text length greater than a predefined threshold number of characters.

7. The method of claim 6, further comprising:
identifying the title candidate whose best cluster candidate has the largest font size;
identifying the title candidate whose best cluster candidate has a longest inner text length;
selecting a best title corresponding to the best cluster candidate having one or more of: the largest font size and the longest inner text length; and
selecting the best cluster candidate corresponding to the best title as a body seed.

8. The method of claim 7, further comprising:
completing the body seed by performing one or more of:
adding paragraphs that have a shorter text length, a different font size, and are lower or deeper in the DOM tree than the body seed;
adding inline images to the body seed; and
adding lists and tables to the body seed.

9. The method of claim 1, further comprising:
filtering the extracted body to remove unrelated content nodes.

10. The method of claim 9, wherein filtering the extracted body further comprises:
applying a set of heuristic rules to identify keywords included in a text node, wherein the keywords indicate one or more of an advertisement, an image, a navigation node, a share-to button, a print link, a display link, an email link, a related story, and a comment; and
removing the text node including the keywords from the body.

11. A server for extracting body and title content from a web page article, comprising:
a memory storing instructions;
a processor coupled to the memory, the processor executing a reader application, wherein the reader application is configured to:
receive a selection of a web page displaying an article;
receive a command to view the article in the reader application;
extract a title of the article from the web page employing an extraction module based on identification of a plurality of title candidates;
extract a body of the article from the web page employing the extraction module based on identification of a plurality of clusters of text nodes; and
display the extracted body and title in a reading view at the reader application.

12. The server of claim 11, wherein the reader application is further configured to:
identify one or more meta tags associated with the title of the web page, wherein the meta tags are one or more of meta title tag, open graph meta tag, and meta content tag;
select one or more title candidates based on text content included within the one or more meta tags; and
filter out a web page name from the text content included within the one or more meta tags.

13. The server of claim 12, wherein the reader application is further configured to:
filter out the web page name from the text content included within the meta tags by identifying an indicator contained within the meta tag, and if only one indicator is identified within the tag, selecting the text after the indicator as the title and removing the text before the indicator.

14. The server of claim 12, wherein the reader application is further configured to:
filter out the web page name from the text content included within the meta tags by:
identifying a last forward slash in a uniform resource locator (URL) of the web page;
selecting a portion of the URL following the last forward slash as the title; and
removing the portion of the text preceding the last forward slash.

15. The server of claim 11, wherein the reader application is further configured to identify the plurality of clusters of text nodes based on identifying text nodes whose inner text length is larger than a threshold length, and grouping two or more text nodes having a same font size and same depth in a cluster.

16. The server of claim 11, wherein the reader application is further configured to select a best candidate for the body from the plurality of clusters of text nodes based on identifying a cluster with a largest font size and a summed text length greater than a predefined threshold number of characters.

17. The server of claim 16, wherein the reader application is further configured to select a best title corresponding to the best candidate for the body.

18. The server of claim 17, wherein the reader application is further configured to adjust the best title based on surrounding text nodes.

19. A computer-readable memory device with instructions stored thereon for extracting body and title content from a web page article, the instructions comprising:
receiving a selection of a web page displaying an article;
filtering a Document Object Model (DOM) tree for the web page based on identification of nodes having a low probability of being part of a body of the article;
receiving a command to view the article in a reader application;
extracting a title of the article from the web page based on identification of a plurality of title candidates;
extracting the body of the article from the web page based on identification of a plurality of clusters of text nodes;
filtering unrelated content from the web page; and
displaying the extracted body and title in a reading view at the reader application.

20. The computer-readable memory device of claim 19, wherein the instructions further comprise:
selecting a best cluster candidate corresponding to a best title as a body seed; and
completing the body seed by performing one or more of:
adding paragraphs that have a shorter text length, a different font size, and are lower or deeper in the DOM tree than the body seed;
adding inline images to the body seed; and
adding lists and tables to the body seed.
